(19) United States
(12) Patent Application Publication
(10) Pub. No.: US 2019/0187356 A1
(43) Pub. Date: Jun. 20, 2019

(54) DISPLAY DEVICE

(71) Applicant: Japan Display Inc., Tokyo (JP)

(72) Inventor: Ken HIRABAYASHI, Tokyo (JP)

(21) Appl. No.: 16/227,110

(22) Filed: Dec. 20, 2018

(30) Foreign Application Priority Data
Dec. 20, 2017 (JP) 2017-243983

(51) Int. Cl. F21V 8/00; G02F 1/1677; G02F 1/1335; G02F 1/133

(52) U.S. Cl. CPC G02B 6/0026; G02F 1/13318; G02F 1/133553; G02F 1/1677

(57) ABSTRACT

According to one embodiment, a display device includes a display panel including a display surface, and an illumination device including a light guide having an emission surface opposing the display surface of the display panel and an incidence surface intersecting the emission surface, a light source configured to emit light entering the incidence surface, and a light cut layer provided between the light source and the incidence surface, to suppress transmission of light having a predetermined wavelength range.

### CROSS-REFERENCE TO RELATED APPLICATIONS

This application is based upon and claims the benefit of priority from Japanese Patent Application No. 2017-243983, filed Dec. 20, 2017, the entire contents of which are incorporated herein by reference.

### FIELD

Embodiments described herein relate generally to a display device.

### BACKGROUND

Liquid crystal displays are widely used as display devices used for smart phones, tablet computers, car-navigation systems, etc. Generally, liquid crystal displays comprise a liquid crystal panel and an illumination device (a backlight or front-light) disposed to be overlaid on a rear surface or a front surface of the liquid crystal panel. The illumination device includes comprises has a light guide, a light source emitting light to enter the light guide, and the like. As the light source, for example, a white light emitting diode (LED) is employed in many cases. The light emitted from white LEDs contains the so-called “blue light”, which is light having a wavelength of 380 to 495 nm. The blue light has properties most close to those of ultraviolet rays, and has such a property that it reaches the retina without being absorbed by the cornea and crystalline lens of eyeballs. Therefore, when the operator sees the blue light for a long time, he or she easily feel eyestrain, which is problematic. Under these circumstances, such a display device has been proposed that a resin layer (blue-light cut layer) to attenuate the blue light is overlaid on a display surface or a rear surface of the liquid crystal panel.

With the above-described display device, it is possible to attenuate the blue light; however, at the same time, the color tone of the display image changes to easily become, for example, yellowish or orange-emphasized, thus, deteriorating the display quality.

### SUMMARY

The present application relates generally to a display device.

According to one embodiment, a display device includes a display panel including a display surface, and an illumination device including a light guide having an emission surface opposing the display surface of the display panel and an incidence surface intersecting the emission surface, a light source configured to emit light entering the incidence surface, and a light cut layer provided between the light source and the incidence surface, to suppress transmission of light having a predetermined wavelength range.

### BRIEF DESCRIPTION OF THE DRAWINGS

FIG. 1 is an exploded perspective view of a liquid crystal display according to a first embodiment.

FIG. 2A is a cross section of a light-source side portion of the liquid crystal display.

FIG. 2B is a cross section a portion of the liquid crystal display, which is on an opposite side to the light source.

FIG. 3 is a plan view schematically showing a light-source side end portion of a light guide and a light source unit.

FIG. 4 is a diagram showing a wavelength distribution of illumination light entering the light guide.

FIG. 5 is a block diagram schematically showing the liquid crystal display.

FIG. 6 is a cross section schematically showing arrangement of the light source and light guide with relative to each other in a liquid crystal display according to a second embodiment.

FIG. 7 is a plan view schematically showing a light source-side end portion of the light guide and a light source portion in a liquid crystal display according to the second embodiment.

FIG. 8A is a plan view schematically showing a light-source side end portion of a light guide and a light source portion in a liquid crystal display according to a modified example.

FIG. 8B is a plan view schematically showing a light-source side end portion of a light guide and a light source portion in a liquid crystal display according to another modified example.

FIG. 8C is a plan view schematically showing a light-source side end portion of a light guide and a light source portion in a liquid crystal display according to another modified example.

FIG. 9 is a perspective view showing a light source-side portion of a front-light device in a liquid crystal display according to a third embodiment.

FIG. 10 is a cross section of the light source-side portion of the liquid crystal display according to the third embodiment.

FIG. 11 is a cross section of a light source-side portion of a display device according to the fourth embodiment.

### DETAILED DESCRIPTION

Various embodiments will be described hereinafter with reference to the accompanying drawings. In general, according to one embodiment, a display device comprises a display panel comprising a display surface and an illumination device comprising a light guide comprising an emission surface opposing the display surface of the display panel, and an incidence surface intersecting the emission surface, a light source emitting light entering the incidence surface, and a light cut layer provided between the light source and the incidence surface, to suppress transmission of light having a predetermined wavelength range.

The disclosure is merely an example, and proper changes in keeping with the spirit of the invention, which are easily conceivable by a person with ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

### First Embodiment

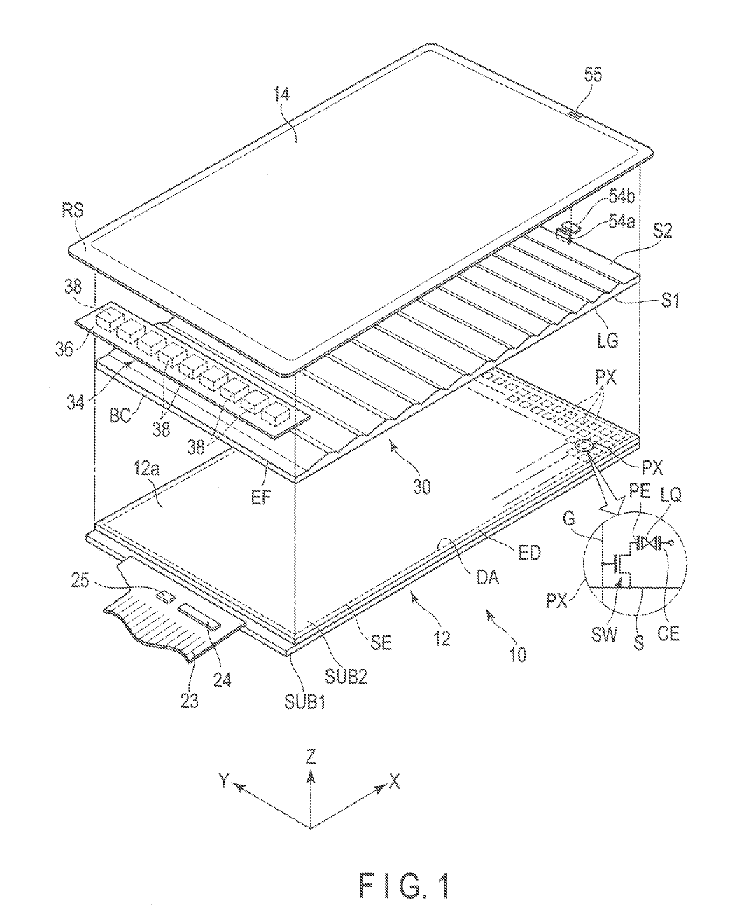

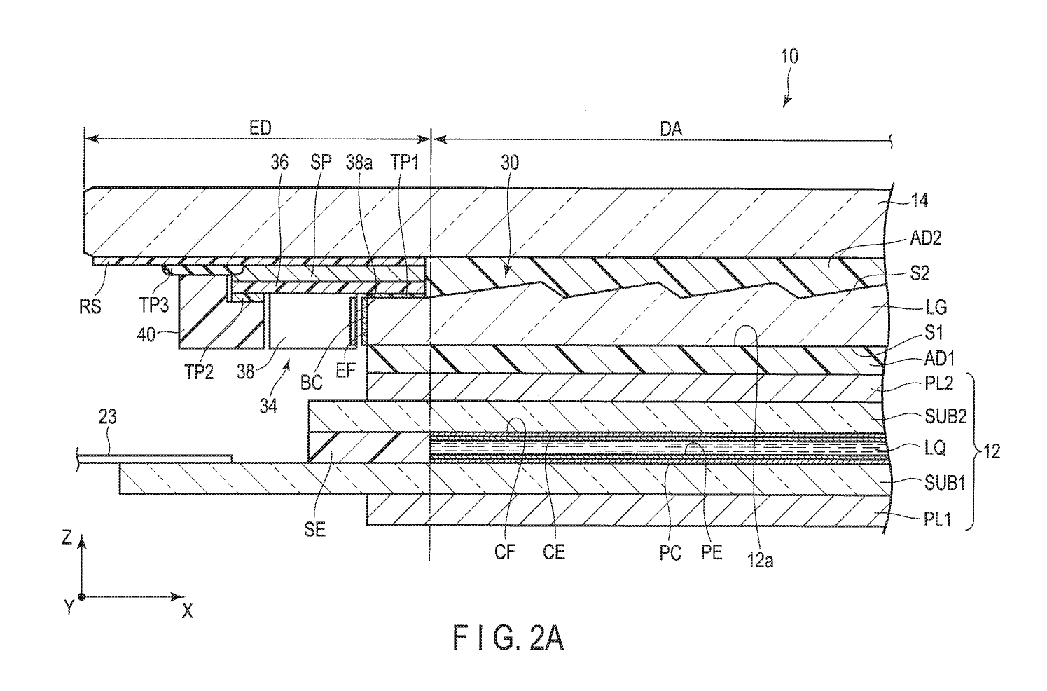

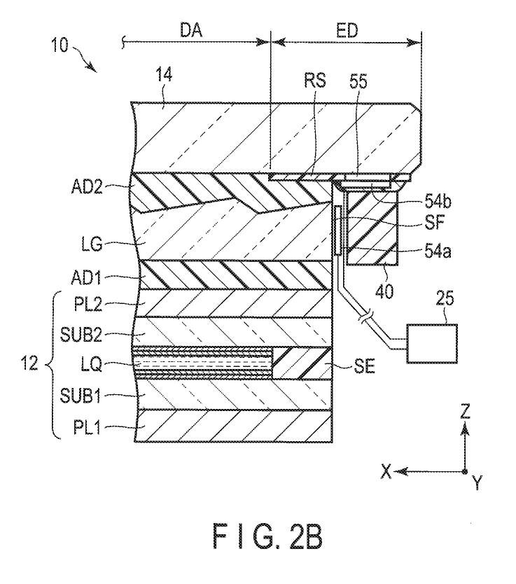

FIG. 1 is an exploded perspective view of a liquid crystal display according to the first embodiment. FIG. 2A is a cross section of a light-source side portion of the liquid crystal display device. FIG. 2B is a cross section a portion of the liquid crystal display device, which is on an opposite side to the light source.

A liquid crystal display device 10 can be built in, for example, various kinds of electronic devices such as smart phones, tablet devices, notebook personal computers, a handheld game machine, electronic dictionaries, television devices, and car-navigation systems.

As shown in FIG. 1, the liquid crystal display device (display device) 10 comprises an active-matrix liquid crystal display panel (to be referred to as “liquid crystal panel” hereinafter) 12, a front-light device 30 disposed as an illumination device to oppose one of flat surfaces of the liquid crystal panel 12, that is, a display surface 12, and a cover panel 14 disposed to be overlaid on the front light device 30 to cover the display surface 12a and the front-light device 30.

As shown in FIGS. 1 and 2A, the liquid crystal panel 12 comprises a rectangular first substrate SUB1, a rectangular second substrate SUB2 opposed to the first substrate SUB1, and a liquid crystal layer LQ held between the first substrate SUB1 and the second substrate SUB2. The second substrate SUB2 is attached by its peripheral portion onto the first substrate SUB1 with a sealing material SE. A polarizer PL2 is attached on a surface of the second substrate SUB2 so as to form the display surface 12a of the liquid crystal panel 12. A polarizer PL1 is attached on a surface of the first substrate SUB1 (a rear surface of the liquid crystal panel 12).

In the liquid crystal panel 12, a rectangular display area (active area) DA is provided in a region located an inner side surrounded by the sealing material SE as viewing the liquid crystal panel 12 in plan view(, which is, here and hereinafter, a state where the liquid crystal panel is viewed from the normal direction of the display surface 12a), and images are displayed on the display area DA. A rectangular frame area ED is provided to surround the display area DA. The liquid crystal panel 12 is a reflective liquid crystal panel which displays images by reflecting external light and the light from the front-light device 30. The liquid crystal panel 12 may be of a structure provided for either one the lateral electric field mode mainly using a lateral electric field along the surface of the substrate, or the vertical electric field mode mainly using a vertical electric field which intersects the surface of the substrate.

The liquid crystal panel 12 comprises a plurality of pixels PX arranged in a matrix in the display area DA. As schematically shown in FIG. 1, the first substrate SUB1 comprises, in the display area DA, gate lines G extending in a first direction X, source lines S extending in a second direction Y which intersects the first direction X, switching elements SW each electrically connected to the respective gate line G and the respective source line S in each respective pixel PX, pixel electrodes PE each connected to the respective switching element SW, and the like. A common electrode CE of common potential is provided on the first substrate SUB1 or the second substrate SUB2 so as to oppose a plurality of pixel electrodes PE.

As shown in FIG. 2A, according to this embodiment, a pixel circuit PC containing a source line S, a gate line G and a switching element SW, a pixel electrode PE formed of a reflecting electrode, and an alignment film (not shown) are formed on an inner surface of the first substrate SUB1. The pixel electrode PE constitutes a reflective film or a reflective layer, which reflects external light and the light from the front-light device 30. On an inner surface of the second substrate SUB2, a color filter CF and a common electrode CE formed of a transparent conducting film such as indium-tin-oxide (ITO), and an alignment film (not shown) are provided. The liquid crystal layer LQ is enclosed between these alignment films.

Thus, the liquid crystal panel 12 of this embodiment is a reflective type which displays images by reflecting external light and the light from the front-light device 30 by the pixel electrodes PE. The reflective film does not limited to the pixel electrode, and another reflective film may be provided on the first substrate SUB1. In a reflective type liquid crystal panel, the polarizer PL1 on the rear surface of the liquid crystal display panel may be omitted.

In the example illustrated, a flexible printed circuit (main FPC) 23 is joined to a short-side end portion of the first substrate SUB1 to extend outward from the liquid crystal panel 12. The main FPC 23 contains semiconductor devices of a driver IC 24, an IC chip 25 which constitutes a controller, mounted therein as signal supply sources which supplies signals required to drive the liquid crystal panel 12.

The front-light device 30 is an auxiliary light source which supplies reflection light to the pixel electrode PE when there is no sufficient external light used as a light source, or no external light. As shown in FIGS. 1 and 2A, the front-light device 30 includes a rectangular light guide LG, a light source unit 34 emit illumination light to enter the light guide LG, a blue-light cut layer (light cut layer) BC provided between an incidence surface of the light guide LG and a light-emitting surface of the light source, a resin frame 40, and a pair of optical sensors. The light guide LG comprises a first main surface S1 as an emission surface, a second main surface S2 opposing the first main surface S1, a pair of long-side side surfaces, and a pair of short-side side surfaces. In this embodiment, one of the short-side side surface of the light guide LG is the incidence surface EF. The light guide LG is formed from, for example, polycarbonate or an acrylic or silicon transparent resin.

The light guide LG is disposed on the liquid crystal panel 12 while the first main surface (emission surface) S1 opposing the display surface 12a of the liquid crystal panel 12. The first main surface S1 is attached onto the polarizer PL2 by, for example, a light-transmissive adhesives or an adhesive AD1. The incidence surface EF is located substantially perpendicular to the liquid crystal panel 12, and extends substantially parallel to the short sides of the second substrate SUB2. As will be described later, in this embodiment, a thin film of the blue-light cut layer BC is formed on the incidence surface EF.

The light source unit 34 comprises, for example, a belt-like wiring substrate 36 and a plurality of light sources mounted and arranged on the wiring substrate 36. As the light sources, light emitting devices, for example, light emitting diodes (LED) 38 are used. As the LED, white LEDs or pseudo-white LED (LED in which a phosphor which glows yellow is disposed on a light-emitting surface of a blue LED) can be used. The wiring substrate 36 is formed from a flexible printed circuit (FPC). A plurality of LEDs 38 are mounted on the FPC 36 and arranged along the short sides of the first substrate SUB1. Each LED 38 comprises a mounting surface 38b to be mounted on the FPC 36 and a light-emitting surface 38a located substantially perpendicular to the FPC 36.

The FPC 36 extends along the incidence surface EF. One side edge portion of the FPC 36 is adhered on a light source-side end portion of the second main surface S2 of the light guide LG by, for example, a double-sided tape TP1. Another side edge portion of the FPC 36 is attached on the resin frame 40 by a double-sided tape TP2. Thus, the FPC 36 is disposed on substantially the same plane as that of the second main surface S2 of the light guide LG

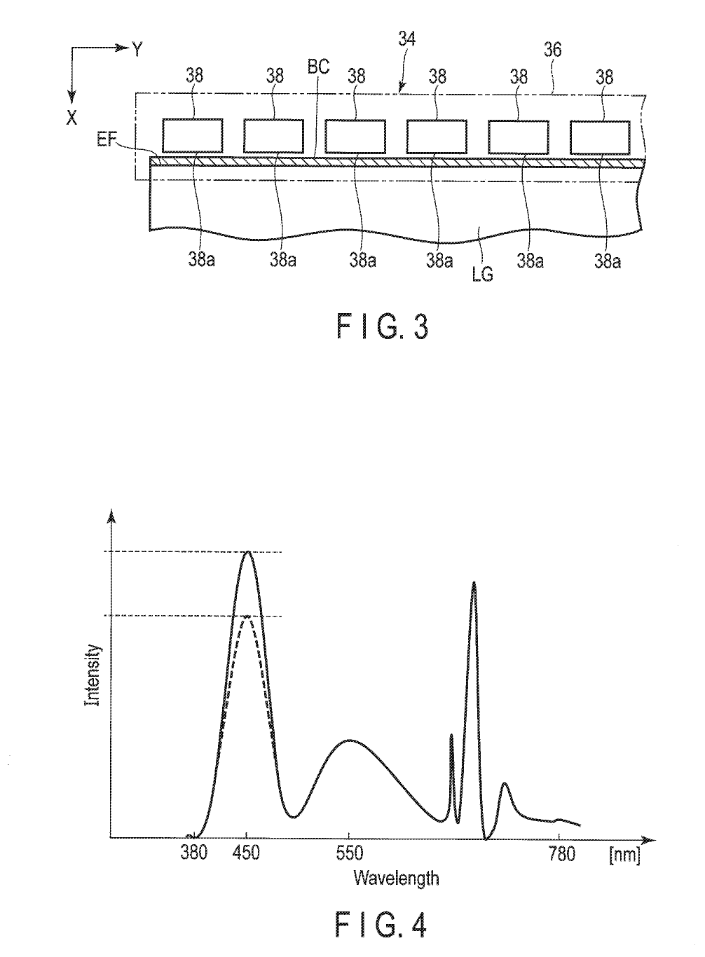

FIG. 3 is a plan view schematically showing the light source-side end portion of the light guide LG and the light source unit 34. As shown in FIGS. 2A and 3, a plurality of LEDs 38 are arranged all along the incidence surface EF at a predetermined gap. The LEDs 38 are arranged in such a state that the light-emitting surfaces 38a adjacently oppose the incidence surface EF of the light guide LG. In this embodiment, the light-emitting surfaces 38a adjacently oppose or are brought into contact in parallel to the blue-light cut layer BC.

As shown in FIGS. 1, 2A and 2B, the cover panel 14 is formed into a rectangular plate from, for example, a glass plate or an acrylic transparent resin. A lower surface (rear surface, a surface on the side of the liquid crystal panel) of the cover panel 14 is attached on the second main surface S2 of the light guide LG by an adhesive layer AD2 made from, for example, a transparent adhesive or tacky agent. In this manner, the cover panel 14 covers the entire surfaces of the front-light device 30 and the display surface 12a of the liquid crystal panel 12.

A frame-like light-shielding layer RS is formed on the lower surface of the cover panel 14. In the cover panel 14, the region of the liquid crystal panel 12, other than the regions opposing the display area DA is shielded by a light-shielding layer RS. The light-shielding layer RS may be formed on the upper surface (outer surface) of the cover panel 14. Note that the cover panel 14 may be omitted in accordance with the condition where how the liquid crystal display 10 is used.

The resin frame 40 of the front-light device 30 is attached on the light-shielding area of the cover panel 14 by, for example, a double-sided tape TP3. Further, in the light-source side end portion, the FPC 36 of the light source unit 34 is brought into contact with the light-shielding layer RS while interposing a spacer SP therebetween.

Next, the blue-light cut layer (light cut layer) BC will be described in detail. The blue-light cut layer BC is formed from a photo-curing resin which is cured by ultraviolet rays or visible light, or a transparent material obtained by mixing a predetermined amount of a coloring material to a base resin of a transparent epoxy resin or the like.

For the base resin, it is preferable to select a type which as an optical transmissivity (to a wavelength of 400 nm or more) after being cured, which is 90% or higher, in order not to lower the optical transmissivity of the light guide LG. Examples of the base resin are a monomer, a polymerization initiator, photo-curing resin, a transparent epoxy resin or the like.

Examples of the coloring material are a perylene-based pigment and an azo-based pigment. These coloring materials dissolve in ethyl alcohol at a predetermined concentration, to be mixed with the base resin. For example, when a photo-curing resin is used as the base resin and a perylene-based pigment is used as the coloring material, the coloring material is dissolved in ethyl alcohol at a ratio of 0.1% by weight, and further mixed into a coloring material solution at 0.1% by weight with respect to the base resin. Thus, the resin material is prepared to contain 0.01% by weight of the coloring material with respect to the base resin.

The resin material is applied on the entire incidence surface EF of the light guide LG, to form the blue-light cut layer BC. Examples of the application method are dispenser application, slot die-coating, slit coater application, screen printing, and spin coating.

The thickness of the coating of the resin material needs to be set according to the concentration of the coloring material mixed to the base resin. For example, when using a photo-curing resin as the base resin and a perylene-based pigment as the coloring material, the thickness of the coating of the resin material should preferably be about 150 to 250 μm, and more preferably 200 μm. In order to cure the resin material applied, for example, the resin material is irradiated with ultraviolet rays in nitrogen atmosphere. In this manner, the resin layer is cured up to its surface, and thus the blue-light cut layer BC can be obtained.

The illumination light emitted from the light-emitting surface 38a of the LED 38 enters the incidence surface EF of the light guide LG, after passing through the blue-light cut layer BC. FIG. 4 shows spectral characteristics of the illumination light. In FIG. 4, a solid line indicates the spectral characteristic of the light emitted from the LED 38 and a dashed line indicates the spectral characteristic of the illumination light after passing through the blue-light cut layer BC. As shown in the figure, by passing through the blue light cut layer BC, a peak value of a light intensity of a wavelength of 380 to 495 nm, which is that of blue light, can be reduced by about 25 to 40% as compared to the case where the blue-light cut layer BC is not provided. Therefore, the blue light cut layer BC has a transmissivity to light of a wavelength of 380 to 495 nm of 60 to 75%, and thus a function of suppressing the transmission of blue light, that is, cutting the blue light by 25 to 40%.

Note that the materials of the blue-light cut layer BC are not limited to the base resin and the coloring material described above, but may be selected from other various materials. Moreover, the transmissivity of the blue-light cut layer BC, i.e., the blue-light cut rate, is not limited to the value mentioned above, but can be adjusted to arbitrary cut rates by adjusting the concentration of the coloring material.

The blue-light cut layer BC is formed to have a uniform thickness over the entire incidence surface EF, but the structure thereof is not limited to this. The blue-light cut layer BC may change its thickness from one place to another, or may be provided in a plurality of locations on the incidence surface EF instead of being formed on the entire surface. Generally, the spectral characteristics of LEDs are uniform, but they may vary from one LED to another (dispersion). Therefore, the thickness of the blue-light cut layer BC or the locations thereof may be changed according to the spectral characteristics of each LED. For example, in the blue-light cut layer BC, the region opposing LEDs with high blue light intensity may be formed thicker than the other regions. Or, the region opposing LEDs with low blue light intensity may be formed thicker than the other regions. Moreover, in the region opposing LEDs with low blue light intensity, the blue-light cut layer BC may be formed thinner than the other regions, or the blue-light cut layer may be even omitted.

As shown in FIGS. 1 and 2B, a light source-side optical sensor 54a and an external light sensor 54b make a pair of optical sensors, and both are formed near a side surface SF which is opposite to the incidence surface EF of the light guide LG. The light source-side optical sensor 54a is disposed in the state the light-receiving surface thereof faces the side surface SF. That is, the light source-side optical sensor 54a is provided at a position which opposes the light source (LED 38) via the light guide LG. Thus, the light source-side optical sensor 54a receives light from the LED light source, having passed through the blue-light cut layer BC and the light guide LG, and detects the wavelength and intensity of the light.

Moreover, the external light sensor 54b is disposed in the state the light receiving surface faces the rear surface of the cover panel 14. The light-shielding layer RS comprises an opening 55 at a position opposing the light-receiving surface of the external light sensor 54b. The external light sensor 54b receives external light having passed through the cover panel 14 and detects the wavelength and intensity of the light. The light source-side optical sensor 54a and the external light sensor 54b are both connected to a controller 56, which will be described later. The optical sensors 54a and 54b may be configured to detect the wavelength and intensity, or to convert the received light into signal data (RAW data) and then output it to the controller 56. In the latter case, the wavelength and intensity of each of light rays are calculated by the controller 56 based on the signals.

The liquid crystal display 10 configured as described above, when used in a bright room or outdoor, reflects external light entering the liquid crystal panel 12 via the cover panel 14 and the light guide LG, by the pixel electrode PE of the liquid crystal panel 12, and displays display images of the liquid crystal panel 12 on the display surface 12a using the reflection light. When used in a dark place, the LEDs 38 of the light source unit 34 are turned on and display images of the liquid crystal panel 12 are displayed on the display surface 12a using the emitted light from the LEDs 38. That is, the light emitted from the light-emitting surface 38a of the LED 38 passes through the blue-light cut layer BC, and enters the light guide LG from the incidence surface EF. During this period, the blue light component of the incidence light is cut by 25 to 40% with the blue-light cut layer BC. The incidence light propagates inside the light guide LG and is reflected by the first main surface S2. Then, it is irradiated from the first main surface S1 towards the liquid crystal panel 12. The irradiated light is reflected by the pixel electrode PE of the liquid crystal panel 12, and the reflection light is used to display the display images of the liquid crystal panel 12 on the display surface 12a.

As described above, the blue-light cut layer BC is provided between the incidence surface of the light guide LG and the light source, and thus the blue light component of the illumination light entering the light guide LG from the LEDs 38 is reduced, thereby making it possible to realize image display easy on eyes. Moreover, when displaying images by reflection of external light, the external light does not pass through the blue-light cut layer BC. Therefore, the image display is not affected by the blue-light cut layer BC, or variation in the color tone thereof can be suppressed, thereby maintaining high quality in display. Thus, according to this embodiment, a liquid crystal display which can display images of high display quality while reducing the blue light can be obtained.

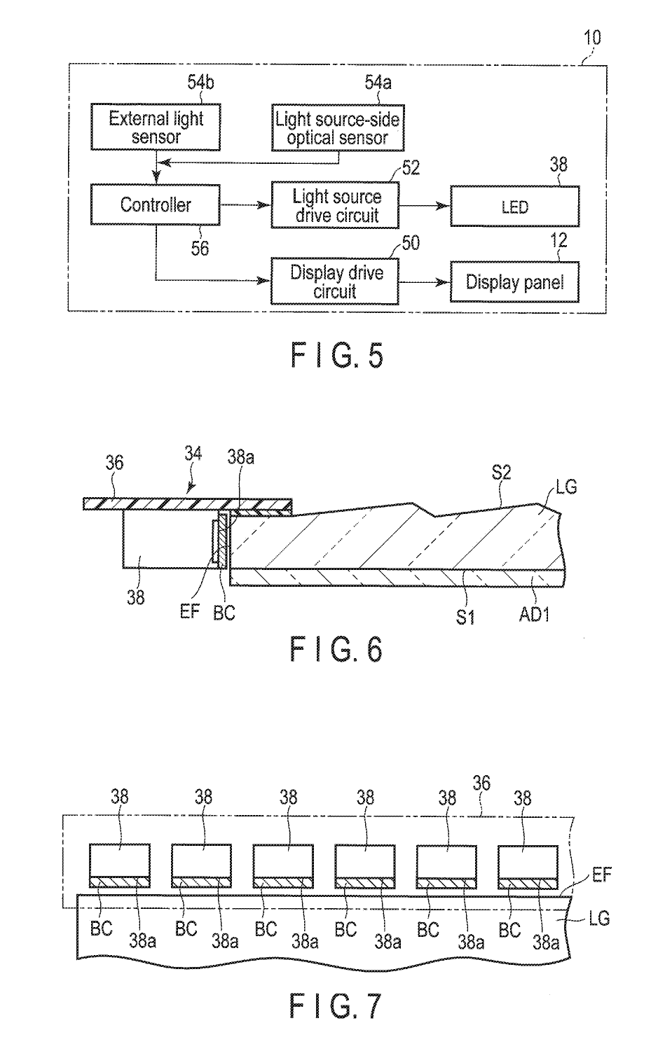

On the other hand, the liquid crystal display 10 according to this embodiment is configured to adjust display images optimally according to the intensity of external light at each wavelength and according to the intensity of the light of the front-light device at each wavelength. FIG. 5 schematically shows an entire configuration of the liquid crystal display. As shown in the figure, the liquid crystal display 10 includes the display drive circuit 50 which drives pixels of the liquid crystal panel 12, the light source drive circuit 52 which drives the LEDs 38 of the light source unit 34, the light source-side optical sensor 54a which detects the intensity (brightness) of the light of the light source unit 34 at each wavelength, the external light sensor 54b which detects the intensity (brightness) of the external light at each wavelength, and the controller (controller) 56 which controls the display drive circuit 50 and the light source drive circuit 52.

The display drive circuit 50 includes the driver IC 24, and a gate drive circuit and a signal line drive circuit (not shown), formed on the first substrate SUB1. The controller 56 and the light source drive circuit 52 are incorporated in the IC chip 25 on the FPC 23 and are provided next to the driver IC 24. Note that such a structure is adoptable as well that either or both of the controller 56 and the light source drive circuit 52 are built in the driver IC.

The controller 56 turns on or off the LEDs 38 by the light source drive circuit 52 according to the light intensity (brightness) at each wavelength, detected by the external light sensor 54b. For example, when a predetermined brightness or higher is detected by the external light sensor 54b, the liquid crystal panel 12 is driven by the display drive circuit 50 to display images without turning on the LEDs 38. In this operation, the controller 56 controls the liquid crystal panel 12 to drive at the optimal display state according to the brightness of the external light. When the intensity of the blue light is high, that is, for example, light from fluorescent lights occupies the majority portion of the external light, is high, the voltage applied to blue pixels is reduced to lower the optical transmissivity of the blue pixels, and thus the color tone of the entire display image is adjusted.

When a predetermined brightness or higher is not detected by the external light sensor 54b, that is, when dark, the controller 56 drives the LEDs 38 to be on by the light source drive circuit 52, and drives the liquid crystal panel 12 by the display drive circuit 50. Thus, the images on the liquid crystal panel 12 are displayed by the illumination light from the LEDs 38 and the external light. Moreover, the illumination light from the LEDs 38 is detected by the light source-side optical sensor 54a via the blue-light cut layer BC and the light guide LG. At this time, the controller 56 adjusts the RGB display of the liquid crystal panel 12 according to the brightness (intensity at each wavelength) of each type of light, detected by the external light sensor 54b and the light source-side optical sensor 54a, thus setting display images of the optimal color tone.

As described above, according to the liquid crystal display of this embodiment, it is possible to perform the optimal image display according to the external light and the illumination light of the front-light device while reducing the blue light.

Next, liquid crystal displays according to other embodiments will be described. In the other embodiment described below, structural parts identical to those of the first embodiment described above will be designated by the same reference numbers, and detailed descriptions therefor may be omitted or simplified. Only the different portions from those of the first embodiment will be mainly described in detail.

### Second Embodiment

FIG. 6 is a cross section showing a light source-side portion of a front-light device in a liquid crystal display according to the second embodiment, and FIG. 7 is a plan view schematically showing the light source-side portion.

As shown in FIGS. 6 and 7, according to this embodiment, a blue-light cut layer is provided on a light-emitting surface 38a of each of LEDs 38. A blue-light cut layer BC is formed by thin film formation on the light-emitting surface 38a of each of the LEDs 38, so as to adjacently oppose the incidence surface EF of the light guide LG. In this embodiment, the blue-light cut layers BC are formed to have a fixed thickness on the light-emitting surfaces 38a of all the LEDs 38, with a common transmissivity.

In the second embodiment, the other structure of the liquid crystal display is the same as that of the liquid crystal display according to the first embodiment described above. With the second embodiment as well, a liquid crystal display of high display quality can be obtained while reducing the blue light.

In the second embodiment, the thickness of the blue-light cut layers BC and the locations where they are formed can be changed arbitrarily. As described above, the spectral characteristics of the LEDs 38 may vary from one LED to another. Therefore, the thickness of the blue light cut layers BC and the locations where they should be formed can be selected according to the spectral characteristics of each LED.

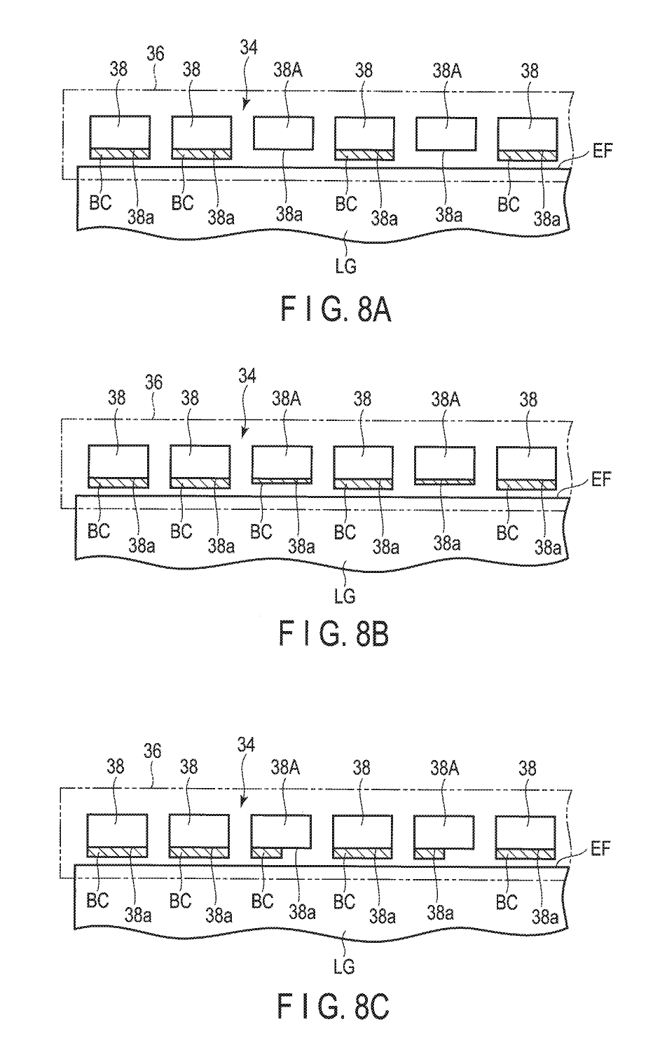

FIGS. 8A, 8B and 8C are plan views schematically showing light source-side portions of the front-light device according to various modified examples, respectively.

As shown in FIG. 8A, according to the first modified example, the blue-light cut layer BC is not formed for LEDs 38A, which have comparatively low wavelength intensity of the blue light, of the plurality of LEDs 38.

As shown in FIG. 8B, according to the second modified example, of the plurality of LEDs 38, LEDs 38A, which have comparatively low wavelength intensity of the blue light, are provided with blue-light cut layer BC thinner than those of the other blue-light cut layers BC.

As shown in FIG. 8C, according to the second modified example, of the plurality of LEDs 38, LEDs 38A, which have comparatively low wavelength intensity of the blue light, are provided with the blue-light cut layer BC not entirely on their light-emitting surfaces 38a, but on, for example, only a half area of each.

### Third Embodiment

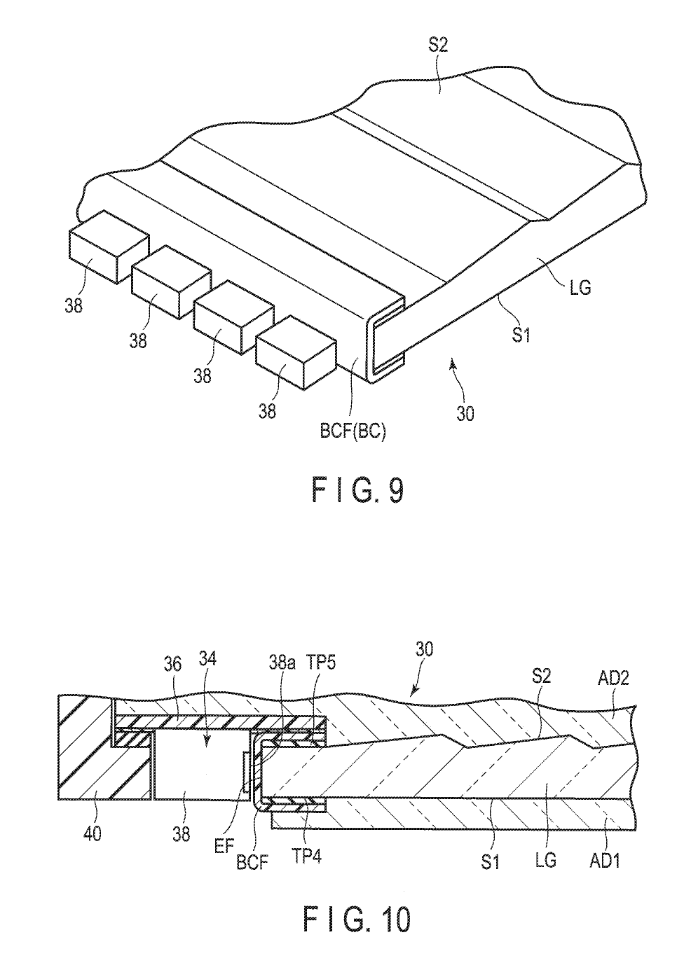

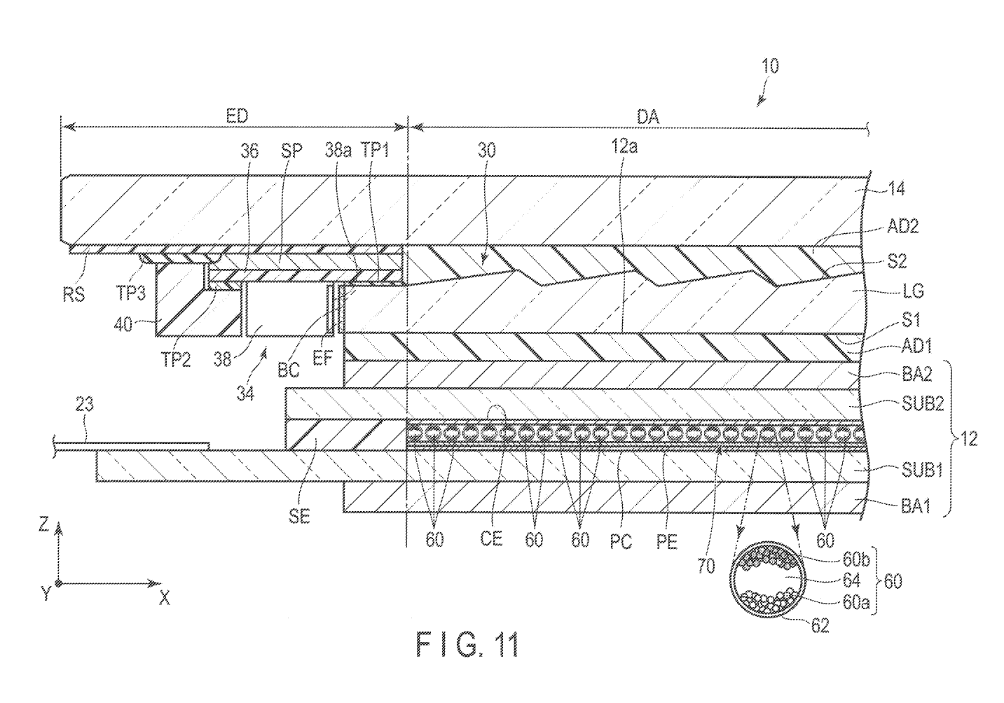

FIG. 9 is a perspective view showing a light source-side portion of a front-light device in a liquid crystal display according to the third embodiment, and FIG. 10 is a cross section schematically showing the light source-side portion.

As shown in FIGS. 9 and 10, according to this embodiment, the front-light device 30 employs a sheet-or film-like blue-light cut layer BC. For example, the blue-light cut sheet BCF is formed by applying a blue light cut layer BC described above on a transparent film. The blue-light cut sheet BCF is disposed between a light-emitting surface 38a of each LED 38 and incidence surface EF of a light guide LG

For example, a blue-light cut sheet BCF is formed into, for example, a belt-like shape and fixed to an incidence-side end portion of the light guide LG. A central portion of the blue light cut sheet BCF along its width direction is tightly attached onto the incidence surface EF, to cover the incidence surface EF. Both edge portions of the blue light cut sheet BCF are bent towards a light guide LG side and are adhered onto end portions of the first main surface S1 and the second main surface S2 by double-sided tapes TP4 and TP5, respectively. On a second main surface S2, an FPC 36 of the light source unit 34 is attached to partially overlap a respective side edge portion of the blue light cut sheet BCF. Note that the blue-light cut sheet BCF may be brought into contact with the light guide LG by its film side or blue-light cut layer BC.

In the third embodiment, the other structure of the liquid crystal display is the same as that of the liquid crystal display according to the first embodiment described above. Even when a sheet-like blue-light cut layer is employed as in the third embodiment, a liquid crystal display of high display quality can be obtained while reducing the blue light.

Note that in the third embodiment described above, the blue-light cut sheet BCF is not limited to the size which covers the entire incidence surface EF, but may be of a size which partially covers arbitrary regions of the incidence surface.

### Fourth Embodiment

FIG. 11 is a cross section of a light source-side end portion of a display device according to the fourth embodiment. As shown, according to the fourth embodiment, a display panel 12 which employs an electrophoretic element is used as a display panel of the display device 10.

The display panel 12 comprises a rectangular plate-shaped first substrate SUB1, a rectangular plate-shaped second substrate SUB2 disposed to oppose the first substrate SUB1, and an electrophoretic element 70 held between the first substrate SUB1 and the second substrate SUB2. The second substrate SUB2 is attached by its peripheral portion onto the first substrate SUB1 by a sealing material SE. A barrier layer BA2 is attached on a surface of the second substrate SUB2, to form a display surface 12a. A barrier layer BA1 is attached on a surface (rear surface of the display panel 12) of the first substrate SUB1.

On an inner surface of the first substrate SUB1, pixel circuits PC including source lines, gate lines, switching elements, and pixel electrodes PE formed of reflecting electrodes are provided. The pixel electrodes PE constitute reflective films or reflective layers provided on the first substrate SUB1. On an inner surface of the second substrate SUB2, a common electrode CE formed of a transparent conducting film such as of ITO, is provided. The electrophoretic element 70 comprises a number of microcapsules 60 dispersedly arranged on substantially an entire area between the first substrate SUB1 and the second substrate SUB2. The electrophoretic element 70 can as well adopt, for example, a sheet type comprising a pair of films formed from a transparent resin and disposed to oppose each other, and microcapsules dispersedly arranged between these films.

The microcapsules 60 have a particle diameter of, for example, about 50 to 100 μm. The microcapsules 60 each comprise a spherical outer shell 62, a plurality of white particles (electrophoretic particles) 60a, a plurality of black particles (electrophoretic particles) 60b and a dispersion medium 64, contained in the outer shell 62. In the example illustrated, only a less number of capsules are schematically shown, one or more microcapsules 60 are formed in a region opposing one pixel electrode PE. The microcapsules 60 are dispersed arranged over the entire display area DA.

In place of the white particles 60a and the black particles 60b, for example, pigments of red, green, blue, yellow, cyan, magenta or the like, may be used. With such structure, red, green, blue, yellow, cyan, magenta and the like can be displayed on the display surface 12a. Or such structure as well is adoptable that particles of one of the above-listed colors are provided in microcapsules in addition to the white particles and black particles.

The display panel 12 is attached onto the first main surface S1 of the light guide LG with, for example, a light-transmissive adhesive or adhesive AD1. In the fourth embodiment, the other structure of the display device which includes, for example, a front-light device 30 and a cover panel 14, is the same as that of the liquid crystal display according to the first embodiment described above. With the fourth embodiment as well, a liquid crystal display of high display quality can be obtained while reducing the blue light.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

All structures which can be implemented by a person of ordinary skill in the art through arbitrary design changes based on the structures described above as the embodiment of the present invention come within the scope of the present invention as long as they encompass the spirit of the present invention. Regarding advantages other than those described in the embodiment, advantages obvious from the description and advantages appropriately conceivable by a person of ordinary skill in the art are regarded as advantages achievable from the present invention as a matter of course.

For example, the LEDs are not limited to a side view type, but top-view LEDs may as well be used. The LEDs are not limited to white light LEDs, but those emitting colors of RGB may as well be used. In this case, the light emission of the front-light device is controlled according to the intensity of external light at each respective wavelength, thereby making it possible to adjust the color tone of display images.

What is claimed is:

1. A display device comprising:
a display panel comprising a display surface; and
an illumination device comprising
a light guide comprising an emission surface opposing the display surface and an incidence surface intersecting the emission surface,
a light source configured to emit light to the incidence surface, and
a light cut layer provided between the light source and the incidence surface, to suppress transmission of light having a predetermined wavelength range.

2. The display device of claim 1, wherein
the light cut layer is a blue-light cut layer which suppress the transmission of light having a wavelength of 380 to 495 nm.

3. The display device of claim 1, wherein
the light cut layer is formed on the incidence surface.

4. The display device of claim 1, wherein
the light cut layer is formed on a light-emitting surface of the light source.

5. The display device of claim 1, wherein
the light source comprises a plurality of light emitting devices each including a light-emitting surface opposing the incidence surface, and
the light cut layer is formed on the light-emitting surface of at least one of the light emitting devices.

6. The display device of claim 1, wherein
the light cut layer is formed into a sheet and disposed between the light source and the incidence surface.

7. The display device of claim 1, wherein
the display panel comprises
a first substrate including a reflecting film which reflects external light,
a second substrate opposed to the first substrate, and
a liquid crystal layer held between the first substrate and the second substrate, and
the light guide of the illumination device is opposed to an outer surface of the second substrate.

8. The display device of claim 1, wherein
the display panel comprises
a first substrate including a reflecting film which reflects external light,
a second substrate opposed to the first substrate, and
an electrophoretic element held between the first substrate and the second substrate, and
the light guide of the illumination device is opposed to an outer surface of the second substrate.

9. The display device of claim 1, further comprising:
an external light sensor which detects wavelength intensity of external light;
a light source-side optical sensor which detects wavelength intensity of the light source; and
a controller which controls display by the display panel according to each of the wavelength intensities detected by the external light sensor and the light source-side optical sensor.

10. The display device of claim 9, wherein
the controller turns on the light source according to the wavelength intensity detected by the external light sensor.

11. The display device of claim 9, wherein
the light source-side optical sensor is provided in a position opposing the light source via the light guide.

12. The display device of claim 2, wherein
the display panel comprises
a first substrate including a reflecting film which reflects external light,
a second substrate opposed to the first substrate, and
a liquid crystal layer held between the first substrate and the second substrate, and
the light guide of the illumination device is opposed to an outer surface of the second substrate.

13. The display device of claim 2, wherein
the display panel comprises
a first substrate including a reflecting film which reflects external light,
a second substrate opposed to the first substrate, and
an electrophoretic element held between the first substrate and the second substrate, and
the light guide of the illumination device is opposed to an outer surface of the second substrate.

14. The display device of claim 2, further comprising:
an external light sensor which detects wavelength intensity of external light;
a light source-side optical sensor which detects wavelength intensity of the light source; and
a controller which controls display by the display panel according to each of the wavelength intensities detected by the external light sensor and the light source-side optical sensor.

15. The display device of claim 14, wherein
the controller turns on the light source according to the wavelength intensity detected by the external light sensor.

16. The display device of claim 14, wherein
the light source-side optical sensor is provided in a position opposing the light source via the light guide.
